(19) United States
(12) Patent Application Publication
(10) Pub. No.: US 2007/0064854 A1
(43) Pub. Date: Mar. 22, 2007

(54) Data processing apparatus and method

(75) Inventor: Tsutomu Hirasawa, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/573,659

(22) PCT Filed: Jul. 28, 2005
(86) PCT No.: PCT/JP05/13832

§ 371 Date: Mar. 28, 2006

(30) Foreign Application Priority Data
Aug. 4, 2004 (JP) 2004-227542
Jul. 27, 2005 (JP) 2005-217444

(51) Int. Cl. H04L 23/00

(52) U.S. Cl. 375/377

(57) ABSTRACT

The present invention relates to a data processing apparatus and method for using recording media effectively and providing enhanced user friendliness. An operating control input section receives an operating control input from the user. When a copy process is designated by the received operating control input, a copy execution section in a memory card reader reads data from a memory card and transmits the read data to a portable terminal. The portable terminal copies the received data onto a disc. A retention section in the memory card reader stores a status that indicates whether the copy process was successful or not. After termination of the copy process, a mode switching section selects a sleep mode as the power supply mode for the memory card reader. When the user performs a procedure for checking the result of the copy process, a check execution section presents the result of the copy process to the user in accordance with the status stored in the retention section. The present invention can be applied to a memory card reader.

### TECHNICAL FIELD

The present invention relates to a data processing apparatus and method, and more particularly to a data processing apparatus that can be battery-driven to transmit data recorded on a recording medium to another apparatus, and a data processing method.

### BACKGROUND ART

In recent years, digital cameras are remarkably widespread so that their users often carry them around when they travel. Images shot with a digital camera are usually recorded in a memory card or other small-size recording medium that can be inserted into the digital camera. When a user comes home from traveling, the user operates his/her personal computer to read images shot with a digital camera and display or print them for enjoyment purposes.

A memory card reader is also developed for reading images and other data recorded in the memory card and supplying them to a personal computer.

The memory card reader is usually connected to the personal computer via a USB (Universal Serial Bus) cable. Therefore, the personal computer supplies power to the memory card.

Further, recent digital cameras exhibit increased resolution. Therefore, the amount of data contained in a single image is increased with an increase in the resolution. Furthermore, the recent digital cameras have a movie shooting capability. This has also increased the amount of data handled by the digital cameras. The storage capacity of the memory card generally ranges from 32 megabytes to 128 megabytes. When, for instance, a large number of photographs and movies are shot during a long-term travel, the storage capacity of the memory card is not adequate. Therefore, the memory card needs to be replaced during a travel. However, when a plurality of memory cards are used, it is burdensome for the user to keep track of which memory card stores what images because the memory cards are similar to each other in appearance. Moreover, since the memory cards are extremely small, they might be lost or damaged during a travel.

As such being the case, the user should transfer the image data acquired by a digital camera to a personal computer as soon as possible. However, it is burdensome for the user to carry a personal computer around during a travel. Under these circumstances, proposed is a technology for recording both music data and image data in a portable, small-size terminal for playing back music and the like.

When the data for an image shot by a digital camera can be easily recorded in the above-mentioned portable, small-size terminal, user friendliness can be enhanced.

### DISCLOSURE OF INVENTION

However, a conventional memory card reader receives power from a personal computer that is connected via a USB cable. Therefore, no data can be copied if the personal computer serving as a power source is not available. Even when the memory card reader is battery-driven, the battery power is not adequate for a long-term travel. Eventually, the memory card reader and recording media such as memory cards and disks cannot be effectively used.

The present invention has been made in view of the above circumstances and provides an apparatus and method for using recording media effectively and enhancing user-friendliness.

According to one aspect of the present invention, there is provided a data processing apparatus for transmitting data recorded on a recording medium to another apparatus, the data processing apparatus comprising: playback means for reading data from the recording medium and playing back the read data; communication means for communicating with the other apparatus; first operation means for receiving an operating control input from the user; presentation means for presenting information to the user; time measurement means for measuring time; a power supply for supplying power; storage means for retaining stored data even when no power is supplied; transmission control means, which, when the first operation means is operated, causes the communication means to transmit the recorded data, which is recorded on the recording medium and played back by the playback means, to the other apparatus, causes the presentation means to present the result of the data transmission, and causes the storage means to store the result of the data transmission; and power control means for causing the time measurement means to measure the time elapse after the information presentation and controlling the power supplied from the power supply after the elapse of a predetermined period of time.

The data processing apparatus may further comprise second operation means for receiving an operating control input from the user; and presentation control means, which, when the second operation means is operated while the power supply to the apparatus from the power supply is controlled, causes the presentation means to present the transmission result of the data stored in the storage means.

The other apparatus is an apparatus for recording data onto another recording medium. The data transmitted by the communication means may be recorded on the other recording medium by the other apparatus.

The data processing apparatus may further comprise comparison means for acquiring a free space remaining on the other recording medium, on which the other apparatus records data, from the other apparatus via the communication means, and comparing the acquired free space remaining on the other recording medium against the amount of data recorded on the recording medium. When the comparison result generated by the comparison means indicates that the other recording medium has an adequate free space for recording the data recorded on the recording medium, the transmission control means may transmit the data to the other apparatus.

When the amount of data recorded on the recording medium is found to be larger than the free space remaining on the other recording medium, the transmission control means may control the storage means to store data that indicates a process failure.

The data processing apparatus may further comprise battery connection means for connecting the power supply to a battery and another connection means for connecting the power supply to a power supply device that differs from the battery. The power supply may notify the power control means of a power source. When a received notification indicates that power is supplied from the battery, the power control means may control the power supplied from the power supply after the elapse of a predetermined period of time is detected by the time measurement means.

The data processing apparatus may further comprise remaining battery power judgment means for judging the remaining power of the battery connected to the battery connection means. When a judgment result generated by the remaining battery power judgment means indicates that the power required for data transmission to the other apparatus cannot be acquired from the battery, the transmission control means may abort the transmission of the data and control the storage means to store data indicating that the data transmission is aborted due to insufficient remaining battery power.

The presentation means may be incorporated in the first operation means.

The presentation means may be an LED (Light Emitting Diode).

The communication means may be a USB (Universal Serial Bus).

According to one aspect of the present invention, there is provided a data processing method for use in a data processing apparatus for transmitting data recorded on a recording medium to another apparatus, the data processing method comprising the steps of: detecting that first operation means is operated by the user; presenting the result of the transmission of data read from the recording medium to the other apparatus and storing status information indicating the transmission result in storage means that stores data even when no power is supplied; measuring a predetermined period of time; and controlling the supply of power after the elapse of the predetermined period of time.

The data processing method may further comprise the steps of: detecting that second operation means is operated by the user after the supply of power is controlled; reading the status information from the storage means when the second operation means is found to be operated; and presenting the result of the data transmission to the user in accordance with the read status information.

The other apparatus is an apparatus for recording data onto another recording medium. The data transmitted may be recorded on the other recording medium by the other apparatus.

The data processing method may further comprise the steps of: acquiring a free space remaining on the other recording medium, on which the other apparatus records data, from the other apparatus; and comparing the acquired free space remaining on the other recording medium against the amount of data recorded on the recording medium. The data recorded on the recording medium may be transmitted to the other apparatus only when the result of comparison indicates that the other recording medium has an adequate free space for recording the data recorded on the recording medium.

When the amount of data recorded on the recording medium is found to be larger than the free space remaining on the other recording medium, the storage means may store data that indicates a process failure.

The data processing method may further comprise the step of detecting whether the power is supplied from a battery. The supply of the power is controlled after the elapse of a predetermined period of time is detected by the time measurement means only when the power is found to be supplied from the battery.

The data processing method may further comprise the step of judging the remaining power of the battery. When the result of judgment indicates that the power required for data transmission to the other apparatus cannot be acquired from the battery, the transmission of the data may be aborted while allowing the storage means to store data indicating that the data transmission is aborted due to insufficient remaining battery power.

In one aspect of the present invention, it is detected that the first operation means is operated by the user. The result of transmission of the data read from the recording medium to the other apparatus is presented. The storage means for storing data even when no power is supplied stores the status information that indicates the result of the transmission. A predetermined period of time is measured. The supply of power is controlled after the elapse of the predetermined period of time is detected.

According to one aspect of the present invention, recording media can be effectively used to provide enhanced user friendliness.

### BRIEF DESCRIPTION OF DRAWINGS

FIG. 1 illustrates a data recording system according to one embodiment of the present invention;

FIG. 2 illustrates a typical internal configuration of a memory card reader that is shown in FIG. 1;

FIG. 3 illustrates a typical configuration of the software executed by a microcomputer that is shown in FIG. 2;

FIG. 4 is a flowchart illustrating a process that is performed by a memory card reader;

FIG. 5 is a flowchart illustrating a copy process;

FIG. 6 is a flowchart illustrating error handling 1;

FIG. 7 is a flowchart illustrating error handling 2;

FIG. 8 is a flowchart illustrating error handling 3;

FIG. 9 is a flowchart illustrating a portable terminal process; and

FIG. 10 is a flowchart illustrating a check process.

### BEST MODE FOR CARRYING OUT THE INVENTION

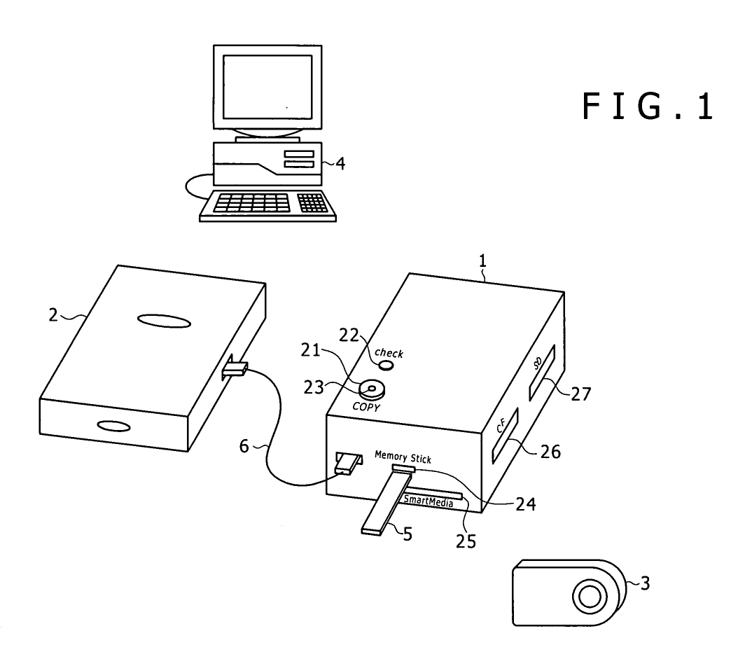

Embodiments of the present invention will now be described with reference to the accompanying drawings. FIG. 1 illustrates a data recording system according to one embodiment of the present invention. In FIG. 1, a digital camera 3 shoots an image as a photograph and records data for the shot image in a memory card 5, which is a small-size recording medium. The memory card 5 can be inserted into and removed from the digital camera 3. It is a card-type flash memory that stores a predetermined number of bytes (e.g., 128 megabytes) of image data. The image data recorded in the memory card 5 can be read via a memory card reader 1. In reality, the memory card 5 is a memory card named, for instance, Memory Stick, SmartMedia, SD Memory Card, xD Picture Card (trademarks), or CompactFlash (registered trademark) (CF).

A portable terminal 2 is a small-size audio apparatus that is carried, for instance, by the user and used for listening to music while the user is away from home or office. A magnetooptical disc or other disc for use with an MD (Mini-Disc) (registered trademark) system is inserted into the portable terminal 2 as a recording medium for musical data recording. The portable terminal 2 accepts three types of discs: a disc used with a current MD system, a next-generation MD1 or Hi-MD1 (trademark) disc which uses the same physical medium as the disc used with the current MD system, and a next-generation MD2 or Hi-MD3 (trademark) disc which has the same outer shape as the disc for use with the current MD system and an increased recording density to increase the recording capacity. The portable terminal 2 plays back data recorded on a disc or records data onto the disc.

The portable terminal 2 uses a FAT (File Allocation Table) system as a file management system for data recording/playback. The aforementioned next-generation MD1 disc and next-generation MD2 disc support the FAT system. It is therefore guaranteed that the portable terminal 2 is compatible with a personal computer 4 or other information processing apparatus. The next-generation MD2 disc can store up to approximately 1 gigabyte of data.

The term “FAT” or “FAT system” is generically used to represent various PC-based file systems. It does not specifically represent a specific FAT-based file system for use with DOS (Disk Operating System), VFAT (Virtual FAT) for use with Windows (registered trademark) 95/98, FAT32 for use with Windows (registered trademark) 98/ME/2000, or NTFS (NT File System or New Technology File System).

The data to be recorded on the disc is not limited to music and other audio data. The portable terminal 2 can also record image data, text data, and other computer data on the disc. Therefore, the portable terminal 2 can record image data, which is transmitted via the memory card reader 1 and recorded on the memory card 5, on the disc.

The portable terminal 2 also includes an interface that accepts a USB (Universal Serial Bus) cable 6, which is used to connect the personal computer 4 and memory card reader 1.

The memory card reader 1 reads the data recorded in a memory card that is inserted into the memory card reader 1, and transmits the read data to another apparatus. The memory card reader 1 is small-sized and lightweight so that it can be carried by the user as is the case with the digital camera 3 and portable terminal 2. The memory card reader 1 operates from a battery or AC power source. When, for instance, the user presses button 21 with the memory card 5 inserted into an inlet 24, the memory card reader 1 reads data that is recorded in the memory card 5, divides the data into predefined data blocks, and transmits the data blocks to the portable terminal 2, which is connected via the USB cable 6. The user can then copy image data, which is acquired by the digital camera 3 and recorded in the memory card 5, to the disc in the portable terminal 2.

The memory card reader 1 is configured to handle one or more types of memory cards. When, for instance, the employed memory card 5 is a Memory Stick, inlet 24, which is compatible with the shape and interface of Memory Stick, should be used for memory card insertion. When the memory card 5 is inserted into inlet 24 in this instance, the data recorded in the memory card 5 can be read. Inlets 25 to 27 are compatible with SmartMedia, CompactFlash (registered trademark), and SD Memory Card, respectively. The memory card reader 1 may be configured to accept a memory card other than these types of memory cards. Alternatively, the memory card reader 1 may be configured to accept only one memory card type.

The memory card reader 1 includes a display section 23, which notifies the user of a copy result after completion of a copy process. The display section 23 incorporates, for instance, green and red LEDs (Light Emitting Diodes). When, for instance, a copy process is performed normally (is successful), the green LED glows steadily. When, for instance, a copy process is not performed normally (is unsuccessful), the red LED glows steadily or blinks. This permits the user to know whether the copy process is performed normally or not.

An unsuccessful copy process may be attributable, for instance, to insufficient free disc space in the portable terminal 2, an improperly connected USB cable 6, or insufficient remaining battery power of the memory card reader 1. When, for instance, a copy process has failed, the red LED may glow steadily or blink depending on the cause of the copy process failure.

When the user carries the memory card reader 1 during a travel or the like, it is usually battery-driven. Therefore, when a predetermined period of time elapses after termination of a copy process, the memory card reader 1 automatically turns off (goes into a sleep mode as described later) for power consumption reduction purposes. If the user wants to check the result of the copy process after the predetermined period of time elapses subsequently to the termination of the copy process, the user presses button 22.

When button 22 is pressed, the memory card reader 1 drives an LED in the display section 23 in accordance with the result of the last-executed copy process to notify the user of the result. If, for instance, the user uses the memory card reader 1 to copy the data recorded in the memory card 5 to the disc in the portable terminal while the user is asleep in a situation where the process for copying the data takes a long period of time, the user can check the result of the copy process after he/she wakes up. This will prevent the user from inadvertently erasing the data from the memory card 5 when the copy process was unsuccessful. Consequently, it is possible to minimize the power consumption of the memory card reader 1, optimize the battery life, and allow the user to use the memory card reader 1 without particular constraints even while the memory card reader 1 is battery-driven.

The personal computer 4 incorporates, for instance, an application program for displaying or editing image data. The user can connect the portable terminal 2 to the personal computer 4 with a USB cable, and operate the personal computer 4 to display or print image data that is recorded on the disc in the portable terminal 2.

For example, the user carries the digital camera 3, portable terminal 2, and memory card reader/writer 1 when he/she travels. During a travel, the user shoots a still picture or movie with the digital camera 3. The data for a shot image is then stored in the memory card 5. However, when the storage capacity (e.g., 128 megabytes) of the memory card 5 is used up to record still pictures or movies, no more images can be recorded. In this instance, new still pictures and movies cannot be recorded until the image data recorded in the memory card 5 is deleted.

Consequently, the user uses the memory card reader 1 to read the image data recorded in the memory card 5 and copy the read image data to the disc in the portable terminal 2. If, for instance, the next-generation MD1 disc is used in the portable terminal 2, it can store up to approximately 300 megabytes of data. If the next-generation MD2 disc is used in the portable terminal 2, it can store up to approximately 1 gigabyte of data. Even if the disc is used to record music or other audio data, the disc is still capable of storing additional data. When the user copies the image data recorded in the memory card 5 to the disc in the portable terminal 2 and erases the image data recorded in the memory card 5, the user can continue to shoot still pictures and movies without losing previously recorded image data.

After coming home from a travel, the user can operate the personal computer 4 to display or print still pictures or movies, which were shot during the travel, for enjoyment purposes. In this manner, the media such as the memory card 5 and the disc in the portable terminal 2 can be effectively used.

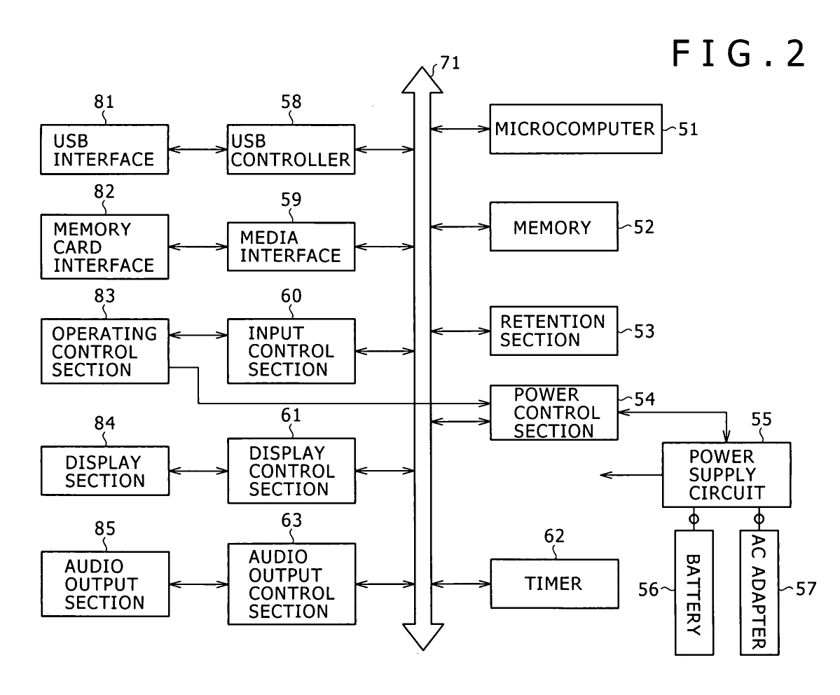

FIG. 2 is a block diagram illustrating a typical internal configuration of the memory card reader 1, which is shown in FIG. 1. A microcomputer 51, which is shown in FIG. 2, operates on an input signal (data) to perform computations, and outputs a signal (data) for controlling various sections of the memory card reader 1. A memory 52 stores, for instance, the program to be executed by the microcomputer 51 and the data necessary for various process executions by the microcomputer 51 as needed. The memory 52 is also used to temporarily buffer the data read from the memory card 5 before it is written onto the disc in the portable terminal 2.

A retention section 53 stores, for instance, a status indicating whether a copy process is performed normally by the memory card reader 1. The retention section 53 comprises an EEPROM (Electronically Erasable and Programmable Read Only Memory) or other nonvolatile memory, and retains the aforementioned status even when no power is supplied to the memory card reader 1. The retention section 53 may be built in the microcomputer 51.

A power control section 54 controls a power supply circuit 55 to regulate the supply of power to the memory card reader 1. In accordance with the control operation performed by the power control section 54, the power supply circuit 55 supplies power, which is output from a battery 56 or an AC adapter 57, to the entire memory card reader 1. It is assumed herein that the power output from the battery or AC adapter is supplied. However, an alternative is to incorporate an additional function for directly receiving AC power and converting the received AC power into power for use in the memory card reader 1.

While the power supply circuit 55 supplies power from the battery 56, the power control section 54 switches between a normal mode and a sleep mode. The normal mode is a power supply mode for allowing the memory reader 1 to perform a normal process (e.g., a copy process). The sleep mode is a power supply mode for controlling the power consumption of the memory card reader 1 while it is on standby (not performing any particular process). Even when the memory card reader 1 is battery-driven during, for instance, a travel, the memory card reader 1 therefore remains in the sleep mode while it is on standby. Consequently, the user can continuously use the memory card reader 1 even during a long travel.

The power control section 54 also receives an operation signal input from an operating control section 83. If an operation signal input is received from the operating control section 83 while the supply of power is minimized or stopped by the power supply circuit, the power control section 54 instructs the power supply circuit to start supplying power. When the power supply circuit 55 completely stops the supply of power, the operation signal output from the operating control section 83 may be directly supplied to the power supply circuit 55. In this manner, it is possible to reduce the power that is consumed while the memory card reader 1 is on standby.

A timer 62 makes various time measurements that are required in the memory card reader 1. For example, the timer 62 counts the time for a predetermined period in order to control the power for the memory card reader 1 when the predetermined period of time elapses after the end of a copy process.

A USB controller 58 controls the communication with another apparatus (e.g., portable terminal 2) that is connected with a USB cable via a USB interface 81. A media interface 59 controls the data input/output relative to the memory card that is inserted into a memory card interface 82. In reality, a plurality of memory card interfaces 82 are furnished in accordance with the memory card types to be supported.

An input control section 60 outputs a command or other data to a bus 71 in response to a signal output from the operating control section 83. The operating control section comprises, for instance, buttons 21 and 22, which are mentioned earlier.

A display control section 61 generates a signal in accordance with the data supplied from the bus 71 to drive a display section 84. As described earlier, the display section 84 comprises, for instance, a green LED and a red LED.

An audio output control section 63 supplies an audio signal to an audio output section 85 so that the audio output section outputs a signal sound, message, or other audio. When, for instance, strong extraneous light is incident on the display section 84, it may be difficult to recognize the status from the indication given by the display section 84. The audio output control section 63 and audio output section 85 are furnished to notify the user of the status of the memory card reader 1 without fail even in the above situation. The audio output control section 63 may convert the status into an audio message and output it. When, for instance, a copy process terminates normally, the audio output section 63 may output the audio message “Copy process is terminated normally.” In this manner, user friendliness can be enhanced.

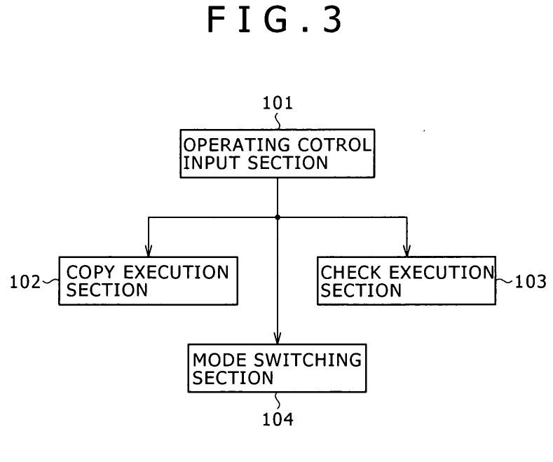

FIG. 3 illustrates a typical functional configuration of the software executed by the microcomputer 51. An operating control input section 101 receives an operating control input from the user via the input control section 60 and controls various sections in accordance with the received operating control input. When a copy process is designated by the received operating control input, that is, when the user presses button 21, a copy execution section 102 exercises control over copy process execution. When a check process is designated by the received operating control input, that is, when the user presses button 22, a check execution section 103 exercises control over check process execution.

A mode switching section 104 switches between the normal mode and sleep mode, which are described earlier.

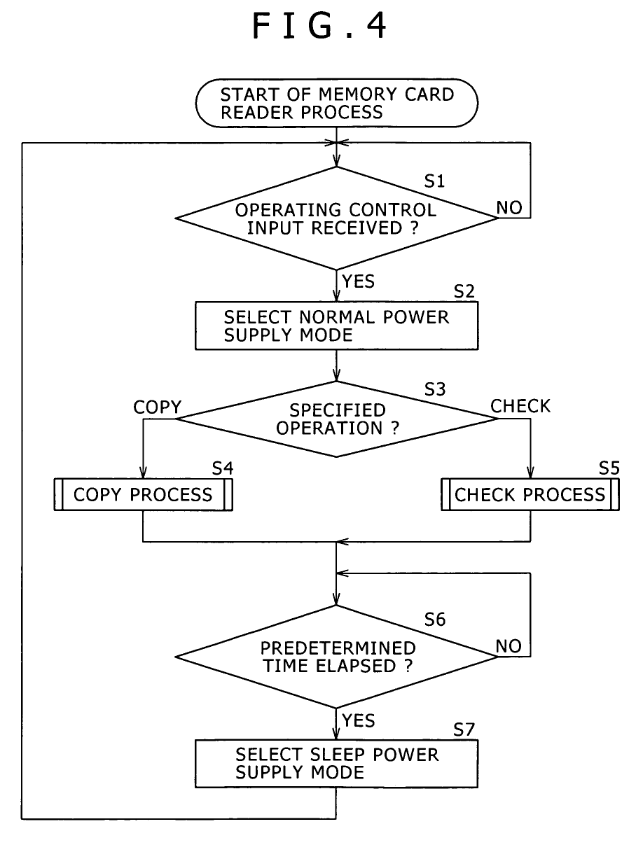

Next, the process performed by the memory card reader 1 will be described with reference to a flowchart in FIG. 4. It is assumed that the memory card reader 1 is driven by the battery 56, and that the memory card reader 1 is connected to the portable terminal 2 via the USB cable 6, and further that the memory card reader 1 operates as a master device according to the USB standard. It is also assumed that the memory card 5 is inserted into the memory card reader 1, and that the next-generation MD2 (or next-generation MD1) disc is inserted into the portable terminal 2.

In step S1, the operating control input section 101 judges whether an operating control input is received from the user, and remains on standby until it judges that an operating control input is received.

When the user operates the operating control section 83, the input control section 60 outputs a command or other data in response to a signal output from the operating control section 83. When data is acquired from the input control section 60, the operating control input section 101 judges that an operating control input is received from the user. Even when the sleep mode prevails as the power supply mode, the power required for the input control section 60 to output a command or other data in response to a signal output from the operating control section 83 is continuously supplied. When the power supply circuit 55 completely stops the supply of power with a view toward power consumption minimization, the power supply circuit 55 may start supplying the power required for the input control section 60 to output a command or other data in response to a signal output from the operating control section 83 in accordance with an operation signal from the operating control section 83, and the input control section 60, which subsequently receives the supply of power, may receive a signal output from the operating control section 83, which is operated by the user, and judge that an operating control input is received from the user.

If the judgment result obtained in step S1 indicates that an operating control input is received from the user, the flow proceeds to step S2. In step S2, the mode switching section 104 selects the normal mode as the power supply mode. The power control section 54 then controls the power supply circuit 55 so that power is supplied in the normal mode to each section of the memory card reader 1. The command or other data that is output from the input control section 60 in accordance with a signal output from the operating control section 83 may be directly acquired by the power control section 54 so as to select the normal mode as the power supply mode.

In step S3, the operating control input section 101 judges the operating control input, which was received from the user in step S1. If button 21, which constitutes the operating control section 83, was pressed by the user, step S3 is performed to judge that a copy process is designated by the operating control input. In this instance, the flow proceeds to step S4. If, on the other hand, button 22, which constitutes the operating control section 83, was pressed by the user, step S3 is performed to judge that a check process is designated by the operating control input. In this instance, the flow proceeds to step S5.

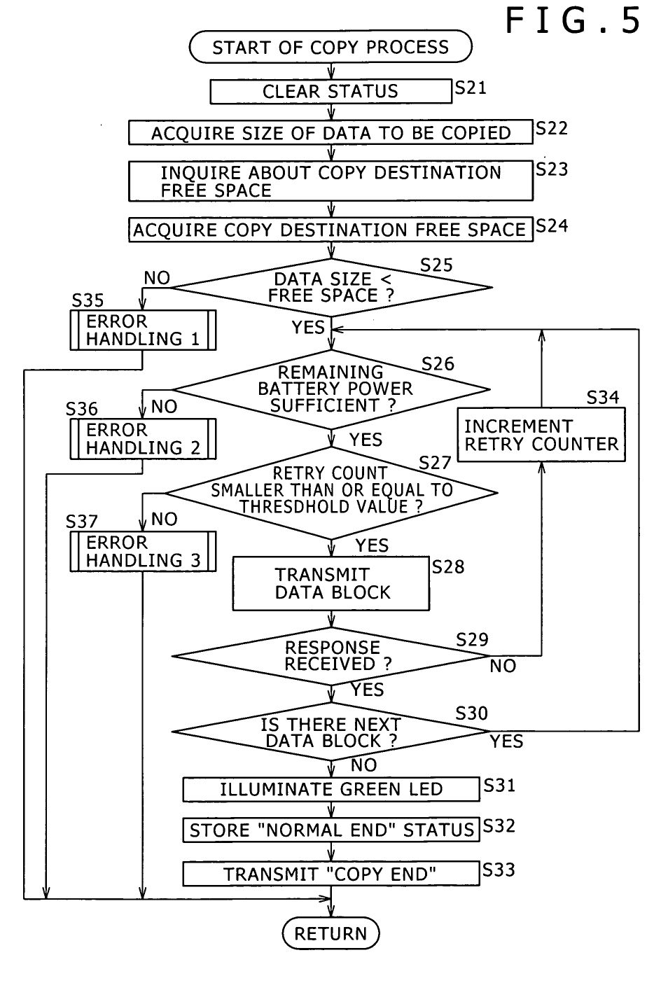

In step S4, the copy execution section 102 performs the copy process, which will be described later with reference to FIG. 5. The data stored in the memory card 5 in the memory card reader 1 is then transmitted to the portable terminal 2 and copied to the disc in the portable terminal 2. An LED in the display section 23 glows steadily or blinks in accordance with the result of the copy process. Further, the audio output section 85 outputs a sound to indicate the result of the copy process.

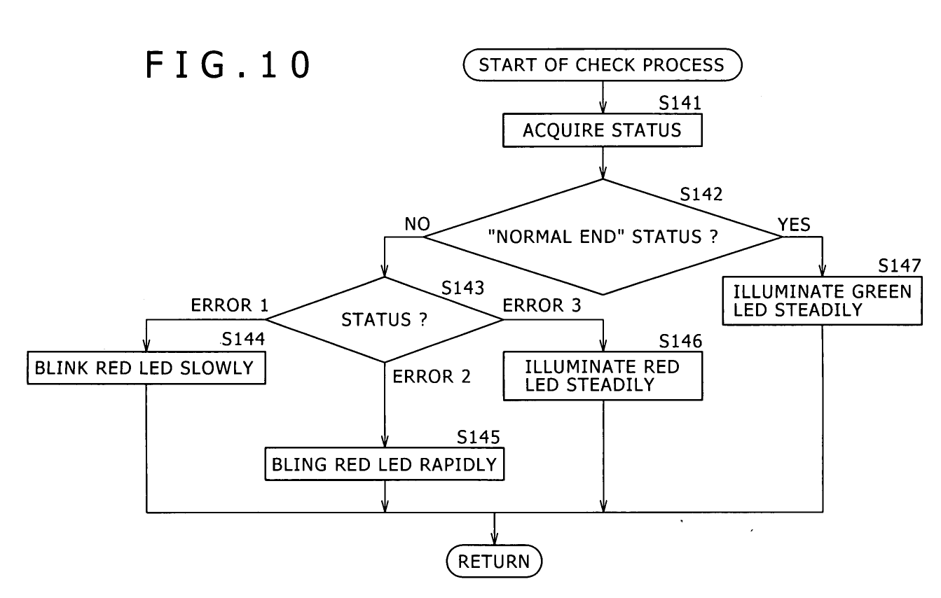

In step S5, the check execution section 103 performs the check process, which will be described later with reference to FIG. 10. An LED in the display section 23 then glows steadily or blinks in accordance with the result of the last-executed copy process. Further, the audio output section 85 outputs a sound to notify the user of the result of the copy process.

In step S6, which follows step S4 or S5, the mode switching section 104 judges whether a predetermined period of time (e.g., a period of 10 seconds) is elapsed, and remains on standby until it judges that the predetermined period of time is elapsed. When it is judged in step S6 that the predetermined period of time is elapsed, the flow proceeds to step S7.

In step S7, the mode switching section 104 selects the sleep mode as the power supply mode. The power control section 54 then controls the power supply circuit 55 so that power is supplied in the sleep mode to each section of the memory card reader 1.

The power consumption of the memory card reader 1 can be reduced in the above manner. Further, the process designated by the operating control input received from the user can be promptly performed without causing the user to worry about battery life. While the power supply circuit 55 supplies power that is output from the AC adapter 57 or other stable power source, neither step S2 nor step S7 is performed to change the power supply mode.

The present embodiment assumes that the power supply mode does not change while power is supplied from a stable power source. However, the present invention is not limited to the use of such a method. Alternatively, the power supply mode may be changed to reduce the power consumption of the memory card reader 1 even when power is supplied from a stable power source. If the power consumption of the memory card reader 1 is reduced while power is supplied from a stable power source, the amount of energy consumption is reduced.

The copy process, which is performed in step S4 as indicated in FIG. 4, will now be described in detail with reference to a flowchart in FIG. 5.

In step S21, the copy execution section 102 clears a status that is retained in the retention section 53.

In step S22, the copy execution section 102 acquires the size of the data to be copied, that is, for instance, the data for an image that is shot with the digital camera 3 and recorded in the memory card 5. In this instance, the sizes of acquired individual data are added up, and the resultant total size is retained.

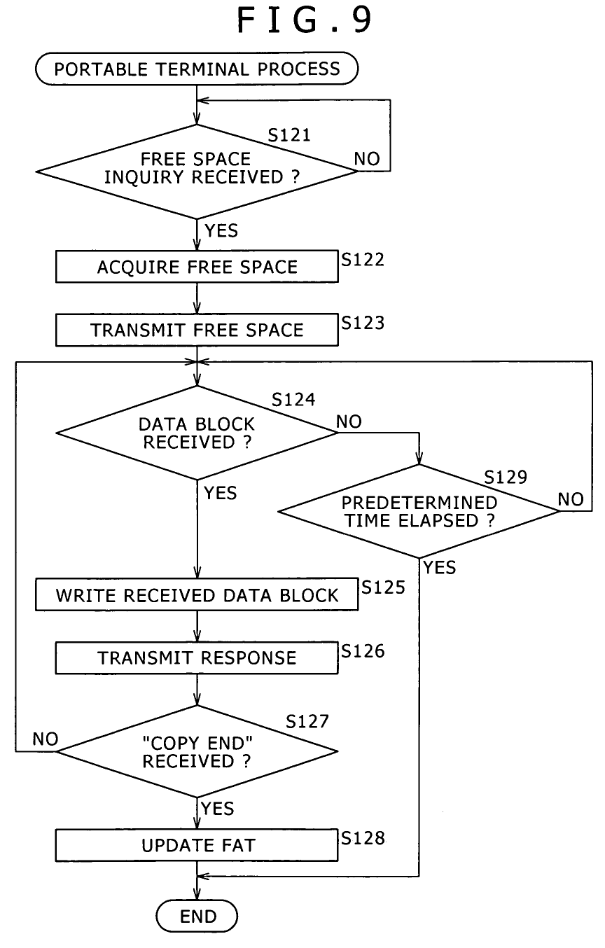

In step S23, the copy execution section 102 inquires about the free space remaining at a copy destination (the free space remaining on the disc in the portable terminal 2 in the present case). In this instance, an inquiry command is transmitted to the portable terminal 2 via the USB cable 6, and the portable terminal 2 returns the free space remaining on the disc to the memory card reader 1. The process performed by the portable terminal 2 will be described later with reference to FIG. 9.

In step S24, the copy execution section 102 acquires the free space remaining at the copy destination (which is returned from the portable terminal 2).

In step S25, the copy execution section 102 compares the total data size derived from the data sizes acquired in step S22 against the free space acquired in step S24, and judges whether the total data size is smaller than the free space, that is, whether the free space remaining on the disc in the portable terminal 2, which is the copy destination, is sufficient. If it is judged that the total data size is smaller than the free space, the flow proceeds to step S26.

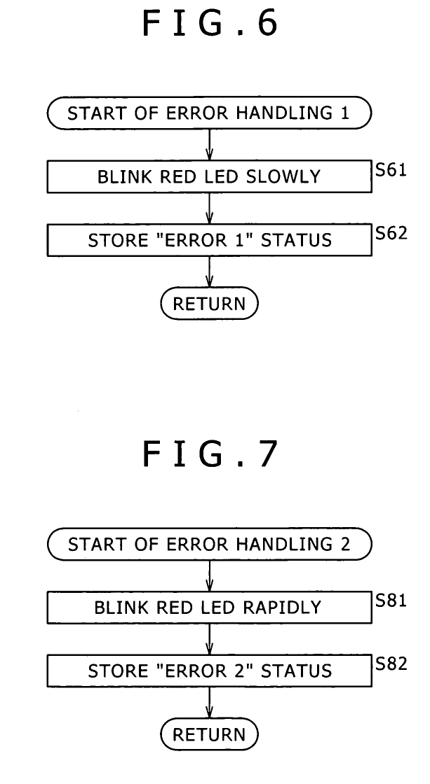

If, on the other hand, it is judged in step S25 that the total data size is not smaller than the free space, that is, the free space remaining on the disc in the portable terminal 2, which is the copy destination, is insufficient, the data cannot be copied. Therefore, the flow proceeds to step S35. In step S35, the copy execution section 102 performs error handling 1, which will be described later with reference to FIG. 6. In this case, the copy process is unsuccessful.

In step S26, the copy execution section 102 judges whether the remaining power of the battery 56 is sufficient. If it is judged that the remaining power of the battery 56 is sufficient, the flow proceeds to step S27. For example, when the remaining power of the battery 56 is low, the power supply circuit 55 issues a warning via the power control section 54. When the warning is received, it is judged that the remaining power of the battery 56 is insufficient. If it is judged in step S26 that the remaining power of the battery 56 is insufficient, the data cannot be copied. Therefore, the flow proceeds to step S36. In step S36, the copy execution section 102 performs error handling 2, which will be described later with reference to FIG. 7. In this case, the copy process is unsuccessful.

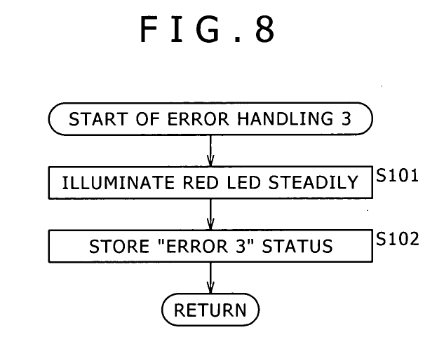

In step S27, the copy execution section 102 judges whether the value of a retry counter, which will be described later, is greater than a threshold value. If it is judged that the value of the retry counter is not greater than the threshold value, the flow proceeds to step S28. As described later, the retry counter is incremented each time the data is retransmitted. If the value of the retry counter is greater than the threshold value, it might be impossible to transmit the data to the portable terminal 2 due, for instance, to an improperly connected USB cable 6. If, on the other hand, it is judged in step S27 that the value of the retry counter is greater than the threshold value, the data cannot be copied. Therefore, the flow proceeds to step S37. In step S37, the copy execution section 102 performs error handling 3, which will be described later with reference to FIG. 8. In this case, the copy process is unsuccessful.

In step S28, the copy execution section 102 transmits a data block to the portable terminal 2 via the USB cable 6. The data block is read from the memory card and a part of the data to be copied. It is of a predetermined size. When data is read from the memory card 5, it is transmitted to the portable terminal 2 on an individual data block basis. More specifically, the data read from the memory card 5 is first stored in the memory 52, read from the memory 52 in accordance with the size of data reception by the portable terminal 2, and then transmitted to the portable terminal 2. Upon receipt of the data block, the portable terminal 2 returns a response to the memory card reader.

In step S29, the copy execution section 102 judges whether the response from the portable terminal 2 is received. If it is judged that the response from the portable terminal 2 is received, the flow proceeds to step S30. If, on the other hand, it is judged in step S29 that the response from the portable terminal 2 is not received, the already transmitted data block might not be received by the portable terminal 2. Therefore, the flow proceeds to step S34. In step S34, the copy execution section 102 increments the retry counter by one (the retry counter indicates the number of data block retransmissions). After completion of step S34, the flow returns to step S26. Subsequently, step S28 is performed to retransmit the same data block.

In step S30, the copy execution section 102 judges whether there is the next data block. If it is judged that there is the next data block, the flow returns to step S26 so that steps S26 and beyond are repeatedly performed.

If it is judged in step S30 that there is no more data block, that is, the data to be copied has been entirely transmitted, the flow proceeds to step S31. In this case, the copy process is successful (terminated normally).

In step S31, which is performed subsequently to step S30, the copy execution section 102 illuminates the green LED via the display control section 61. This notifies the user that the copy process was successful and terminated normally.

In step S32, the copy execution section 102 stores a “Normal End” status in the retention section 53 to indicate the result of the copy process. In step S33, the copy execution section 102 transmits data to the portable terminal 2 to report a “Copy End.”

Error handling 1, which is performed in step S35 as indicated in FIG. 5, will now be described in detail with reference to a flowchart in FIG. 6. In step S61, the copy execution section 102 blinks the red LED slowly (e.g., at 0.5-second intervals) via the display control section 61 and outputs an audio message such as “The copy destination capacity is insufficient” to report an unsuccessful copy process. This notifies the user that the copy process was unsuccessful due to insufficient free space at the copy destination.

In step S62, the copy execution section 102 stores an “Error 1” status in the retention section 53 to indicate the result of the copy process. In the current example, the “Error 1” status indicates that the copy process was unsuccessful due to insufficient free space at the copy destination.

Error handling 2, which is performed in step S36 as indicated in FIG. 5, will now be described in detail with reference to a flowchart in FIG. 7. In step S81, the copy execution section 102 blinks the red LED rapidly (e.g., at 0.2-second intervals) via the display control section 61 and outputs an audio message such as “The remaining battery power is insufficient” to report an unsuccessful copy process. This notifies the user that the copy process was unsuccessful due to insufficient remaining battery power.

In step S82, the copy execution section 102 stores an “Error 2” status in the retention section 53 to indicate the result of the copy process. In the current example, the “Error 2” status indicates that the copy process was unsuccessful due to insufficient remaining battery power.

Error handling 3, which is performed in step S37 as indicated in FIG. 5, will now be described in detail with reference to a flowchart in FIG. 8. In step S101, the copy execution section 102 illuminates the red LED steadily via the display control section 61 and outputs an audio message such as “The copy operation was unstable” to report an unsuccessful copy process. This notifies the user that the copy process was unsuccessful due to a data transmission error.

In step S102, the copy execution section 102 stores an “Error 3” status in the retention section 53 to indicate the result of the copy process. In the current example, the “Error 3” status indicates that the copy process was unsuccessful because the data could not be transmitted to the portable terminal 2 (the retry counter threshold value was exceeded).

The data read from the memory card 5 is copied to the disc in the portable terminal 2 as described above. When the copy process has been successful, the green LED in the display section 23 steadily glows. When the copy process has been unsuccessful, the red LED in the display section 23 glows steadily or blinks. In addition, an audio message or other audio output is generated to indicate the status. Therefore, the user is quickly notified of the result of the copy process. Further, if the copy process has been unsuccessful, the status of an LED in the display section 23 varies with the cause of a copy process failure (the LED may glow steadily, blink slowly, or blink rapidly). Therefore, the result of the copy process can be accurately reported to the user. Furthermore, the retention section 53 stores the result of the copy process as a status. This allows the user to check the result of the copy process later.

A typical process that is performed by the portable terminal 2 will now be described with reference to a flowchart in FIG. 9. This process is performed in parallel with a copy process that is performed by the memory card reader 1 as described with reference to FIG. 5.

In step S121, the portable terminal 2 judges whether a free space inquiry is received, and remains on standby until it judges that such an inquiry is received. When a command is transmitted from the memory card reader 1 to the portable terminal 2 via the USB cable 6 in step S23, which is shown in FIG. 5, to inquire about the free space remaining at the copy destination (the free space remaining on the disc in the portable terminal 2 in the current example), the portable terminal 2 receives the command and judges that a free space inquiry is received.

If it is judged in step S121 that a free space inquiry is received, the flow proceeds to step S122. In step S122, the portable terminal 2 acquires the free space remaining on the locally inserted disc. In step S123, the portable terminal 2 transmits the free disc space, which was acquired in step S122, to the memory card reader 1 via the USB cable 6. The transmitted free disc space is then acquired by the memory card reader 1 in step S24, which is shown in FIG. 5.

In step S124, the portable terminal 2 judges whether a data block is received. Step S28, which is shown in FIG. 5, is performed to judge whether the data block transmitted from the memory card reader 1 is received. If it is judged in step S124 that a data block is received, the flow proceeds to step S125. In step S125, the portable terminal 2 writes the received data block onto the locally inserted disc. In step S126, the portable terminal 2 transmits a response concerning the received data block to the memory card reader 1. The transmitted response is received by the memory card reader 1 in step S29, which is shown in FIG. 5.

In step S127, which is performed subsequently to step S126, the portable terminal 2 judges whether “Copy End” is received. If it is judged that “Copy End” is not received, the flow returns to step S124 so that the steps S124 and beyond are repeatedly performed.

When, in step S33, which is shown in FIG. 5, the memory card reader 1 transmits data to the portable terminal 2 via the USB cable 6 in order to report a “Copy End,” the portable terminal 2 receives the transmitted data and judges that “Copy End” is received.

If it is judged in step S127 that “Copy End” is received, the flow proceeds to step S128. In step S128, the portable terminal 2 updates a FAT. As described earlier, the portable terminal 2 uses a FAT (File Allocation Table) system as a file management system for data recording/playback. Therefore, when the FAT is updated, the data written onto the disc in step S125 can be played back (read).

If, on the other hand, it is judged in step S124 that no data block is received, the flow proceeds to step S129. In step S129, the portable terminal 2 judges whether a predetermined period of time has elapsed. If it is judged that the predetermined period of time has not elapsed, the flow returns to step S124.

If, on the other hand, it is judged in step S129 that the predetermined period of time has elapsed, the process terminates. In this instance, the FAT is not updated.

If no data block is received even when the predetermined period of time has elapsed, it is conceivable, for instance, that the free space remaining on the disc in the portable terminal 2 is not enough for the data transmitted from the memory card reader 1, the remaining battery power for the memory card reader 1 is insufficient, or the copy process has been unsuccessful due to a transmission error caused, for instance, by an improperly connected USB cable 6. Consequently, the portable terminal 2 terminates the process without updating the FAT. Even if some data blocks were written on the disc in step S125, the data contained in the written data blocks cannot be played back (read) because the FAT is not updated. In other words, when the memory card reader 1 does not successfully perform the copy process, the data partly written in the portable terminal 2 is invalid (regarded as being nonexistent).

As described above, the portable terminal 2 performs its process in parallel with the copy process performed by the memory card reader 1. FIG. 9 shows an example of a process that is performed by the portable terminal 2. The process performed by the portable terminal 2 is not limited to the one illustrated in FIG. 9.

The check process, which is performed in step S5 as indicated in FIG. 4, will now be described in detail with reference to a flowchart in FIG. 10.

In step S141, the check execution section 103 acquires a status that is stored in the retention section 53.

As described earlier, the retention section 53 comprises an EEPROM or other nonvolatile memory, and retains a status while no power is supplied to the memory card reader 1, that is, while the sleep mode is selected as the power supply mode for the memory card reader 1. Therefore, the status acquired in step S141 is based on the result of the last-executed copy process that was performed in step S4 as indicated in FIG. 4. The status is a piece of information that indicates whether the copy process performed by the memory card reader 1 was successful or not. If the copy process was unsuccessful, one of three different pieces of status information is stored in the retention section. More specifically, the status stored in the retention section is “Normal End,” “Error 1,” “Error 2,” or “Error 3.”

In step S142, the check execution section 103 judges whether a “Normal End” status was acquired in step S141. If it is judged that a “Normal End” status was acquired, the flow proceeds to step S147.

In step S147, the check execution section 103 steadily illuminates the green LED via the display control section 61. This notifies the user that the last-executed copy process was successful (terminated normally).

On the other hand, if it is judged in step S142 that the status was not “Normal End,” the last-executed copy process was considered unsuccessful. Thus, the check execution section 103 judges the type of the status in step S143. In this instance, the check execution section 103 judges that the status acquired in step S141 is “Error 1,” “Error 2,” or “Error 3.”

If it is judged in step S143 that the status is “Error 1,” the flow proceeds to step S144. In step S144, the check execution section 103 blinks the red LED at 0.5-second intervals or other long intervals via the display control section 61. This notifies the user that the last-executed copy process was unsuccessful due to free space insufficiency at the copy destination.

If it is judged in step S143 that the status is “Error 2,” the flow proceeds to step S145. In step S145, the check execution section 103 blinks the red LED at 0.2-second intervals or other short intervals via the display control section 61. This notifies the user that the last-executed copy process was unsuccessful due to insufficient remaining battery power of the memory card reader 1.

If it is judged in step S143 that the status is “Error 3,” the flow proceeds to step S146. In step S146, the check execution section 103 glows the red LED steadily via the display control section 61. This notifies the user that the last-executed copy process was unsuccessful due to a data transmission error.

The result of the copy process is checked as described above. The copy process result check is performed in accordance with the status stored in the retention section. Therefore, if, for instance, the memory card reader 1 is used to copy the data recorded in the memory card 5 to the disc in the portable terminal 2 while the user is asleep, the user can check the result of the copy process when he/she wakes up by pressing button 21 and viewing the indication given by the display section 23. This will prevent the user from inadvertently erasing the data from the memory card 5 when the copy process was unsuccessful.

Further, if the copy process fails, the cause of the failure is also stored as a status. Therefore, the result of the copy process can be accurately reported to the user.

The embodiment described above assumes that the memory card reader 1 and portable terminal 2 are contained in separate housings. Alternatively, however, the memory card reader 1 and portable terminal 2 may be contained in the same housing. As another alternative, the memory card reader 1 and digital camera 3 may be contained in the same housing.

The present invention is not limited to a memory card reader. The present invention can also be applied to a battery-driven apparatus that presents processing results to the user after performing a process for a long period of time.

The series of processes described above can be performed not only by hardware but also by software.

When software performs the series of processes described above, programs constituting the software are installed from a network-connected, remote information processing apparatus or from a removal recording medium such as a memory card.

The steps for performing the series of processes described above not only include the steps performed chronologically in an indicated sequence but also include the steps performed on a parallel basis or individual basis.

1. A data processing apparatus for transmitting data recorded on a recording medium to another apparatus, the data processing apparatus comprising:
playback means for reading data from the recording medium and playing back the read data;
communication means for communicating with the other apparatus;
first operation means for receiving an operating control input from the user;
presentation means for presenting information to the user;
time measurement means for measuring time;
a power supply for supplying power;
storage means for retaining stored data even when no power is supplied;
transmission control means, which, when the first operation means is operated, causes the communication means to transmit the recorded data, which is recorded on the recording medium and played back by the playback means, to the other apparatus, causes the presentation means to present the result of the data transmission, and causes the storage means to store the result of the data transmission; and
power control means for causing the time measurement means to measure the time elapse after the information presentation and controlling the power supplied from the power supply after the elapse of a predetermined period of time.

2. The data processing apparatus according to claim 1, further comprising:
second operation means for receiving an operating control input from the user; and
presentation control means, which, when the second operation means is operated while the power supply to the apparatus from the power supply is controlled, causes the presentation means to present the transmission result of the data stored in the storage means.

3. The data processing apparatus according to claim 1, wherein the other apparatus is an apparatus for recording data onto another recording medium; and wherein the data transmitted by the communication means is recorded on the other recording medium by the other apparatus.

4. The data processing apparatus according to claim 1, further comprising:
comparison means for acquiring a free space remaining on the other recording medium, on which the other apparatus records data, from the other apparatus via the communication means, and comparing the acquired free space remaining on the other recording medium against the amount of data recorded on the recording medium,
wherein, when the comparison result generated by the comparison means indicates that the other recording medium has an adequate free space for recording the data recorded on the recording medium, the transmission control means transmits the data to the other apparatus.

5. The data processing apparatus according to claim 4, wherein, when the amount of data recorded on the recording medium is found to be larger than the free space remaining on the other recording medium, the transmission control means controls the storage means to store data that indicates a process failure.

6. The data processing apparatus according to claim 1, further comprising:
battery connection means for connecting the power supply to a battery; and
another connection means for connecting the power supply to a power supply device that differs from the battery,
wherein the power supply notifies the power control means of a power source; and
wherein, when a received notification indicates that power is supplied from the battery, the power control means controls the power supplied from the power supply after the elapse of a predetermined period of time is detected by the time measurement means.

7. The data processing apparatus according to claim 6, further comprising:
remaining battery power judgment means for judging the remaining power of the battery connected to the battery connection means,
wherein, when a judgment result generated by the remaining battery power judgment means indicates that the power required for data transmission to the other apparatus cannot be acquired from the battery, the transmission control means aborts the transmission of the data and controls the storage means to store data indicating that the data transmission is aborted due to insufficient remaining battery power.

8. The data processing apparatus according to claim 1, wherein the presentation means is incorporated in the first operation means.

9. The data processing apparatus according to claim 1, wherein the presentation means is an LED (Light Emitting Diode).

10. The data processing apparatus according to claim 1, wherein the communication means is a USB (Universal Serial Bus).

11. A data processing method for use in a data processing apparatus for transmitting data recorded on a recording medium to another apparatus, the data processing method comprising the steps of:
detecting that first operation means is operated by the user;
presenting the result of the transmission of data read from the recording medium to the other apparatus and storing status information indicating the transmission result in storage means that stores data even when no power is supplied;
measuring a predetermined period of time; and
controlling the supply of power after the elapse of the predetermined period of time.

12. The data processing method according to claim 11, further comprising the steps of:
detecting that second operation means is operated by the user after the supply of power is controlled;
reading the status information from the storage means when the second operation means is found to be operated; and
presenting the result of the data transmission to the user in accordance with the read status information.

13. The data processing method according to claim 11, wherein the other apparatus is an apparatus for recording data onto another recording medium; and wherein the data transmitted is recorded on the other recording medium by the other apparatus.

14. The data processing method according to claim 11, further comprising the steps of:
acquiring a free space remaining on the other recording medium, on which the other apparatus records data, from the other apparatus; and
comparing the acquired free space remaining on the other recording medium against the amount of data recorded on the recording medium,
wherein the data recorded on the recording medium is transmitted to the other apparatus only when the result of comparison indicates that the other recording medium has an adequate free space for recording the data recorded on the recording medium.

15. The data processing method according to claim 14, wherein, when the amount of data recorded on the recording medium is found to be larger than the free space remaining on the other recording medium, the storage means stores data that indicates a process failure.

16. The data processing method according to claim 11, further comprising the step of:
detecting whether the power is supplied from a battery,
wherein the supply of the power is controlled after the elapse of a predetermined period of time is detected by the time measurement means only when the power is found to be supplied from the battery.

17. The data processing method according to claim 16, further comprising the step of:
judging the remaining power of the battery
wherein, when the result of judgment indicates that the power required for data transmission to the other apparatus cannot be acquired from the battery, the transmission of the data is aborted while allowing the storage means to store data indicating that the data transmission is aborted due to insufficient remaining battery power.
